(19) United States
(12) Patent Application Publication
(10) Pub. No.: US 2008/0115365 A1
(43) Pub. Date: May 22, 2008

(54) Hair removing apparatus

(75) Inventors: Takeshi Matsusaka, Hikone (JP); Tetsuro Hashiguchi, Hikone (JP); Kenichi Muraki, Hikone (JP)

Correspondence Address: BACON & THOMAS, PLLC, 625 SLATERS LANE, FOURTH FLOOR, ALEXANDRIA, VA, 22314, US

(73) Assignee: Matsushita Electric Works, Ltd., Osaka (JP)

(21) Appl. No.: 11/984,129

(22) Filed: Nov. 14, 2007

(30) Foreign Application Priority Data
Nov. 22, 2006 (JP) 2006-315477

(51) Int. Cl. B26B 19/14; B26B 19/38

(52) U.S. Cl. 30/43.5; 30/45

(57) ABSTRACT

A hair removing apparatus for removing hairs by using soap includes a water-resistant body case having a driving source therein; and a hair removing head attached to the water-resistant body case, the hair removing head having a hair removing unit driven by the driving source to pull out the hairs. The hair removing head has a bubble retention member that encloses the hair removing unit to retain soap bubbles therein.

### FIELD OF THE INVENTION

The present invention relates to a hair removing apparatus for removing hairs by using soap.

### BACKGROUND OF THE INVENTION

A conventional hair removing apparatus is disclosed in Japanese Patent Laid-open Application No. 2001-149135. In this hair removing apparatus, a body case has a handheld configuration and a water-resistant structure. The body case has therein a driving source and, also, a hair removing head having a hair removing unit for removing hairs is attached thereto. The hair removing unit has rotatable cylinders and detents disposed around peripheral surfaces of the rotatable cylinders. When the driving source is driven to rotate the rotatable cylinders, the detents open and close in accordance with the rotation, thereby catching and pulling out hairs. When removing the hairs, soap is used. With soap bubbles, the hairs are erected and, the friction between a skin surface and the hair removing unit is reduced, which makes it possible to remove hairs safely. For that reason, the body case has the water-resistant member.

In the above prior art, when the hairs are removed by using soap, soap bubbles are dispersed due to the rotation of the rotatable cylinders having the detents. Thus, the amount of the bubbles on the skin surface is not maintained uniformly, which hinders the hair removing unit from stably erecting hairs with bubbles. Also, the friction between the skin surface and the hair removing unit varies depending on bubble states (that is, contact or followability of the hair removing head to the skin surface becomes poor), thereby deteriorating the hair removal efficiency.

### SUMMARY OF THE INVENTION

In view of the above, the present invention provides a hair removing apparatus allowing a hair removing unit to stably exhibit its function by maintaining the amount of bubbles uniformly when removing hairs by using soap.

In accordance with the present invention, there is provided a hair removing apparatus for removing hairs by using soap including:

a water-resistant body case having a driving source therein; and

a hair removing head attached to the water-resistant body case, the hair removing head having a hair removing unit driven by the driving source to pull out the hairs, wherein the hair removing head has a bubble retention member that encloses the hair removing unit to retain soap bubbles therein.

In accordance with the above configuration, the water-resistant body case having a handheld configuration has the driving source therein, and the hair removing head having the hair removing unit that is driven by the driving source to remove hairs is attached to the water-resistant body case. When removing the hairs, soap is used. With soap bubbles, it is possible to erect the hairs and reduce the friction between a skin surface and the hair removing unit including the rotatable cylinders having the detents. As a consequence, the hair removal can be carried out safely. In this hair removing apparatus, the hair removing head has the bubble retention member which serves as walls enclosing the hair removing unit so that the bubbles can be collected.

Due to the presence of the bubble retention member, the bubbles are prevented from being dispersed by the hair removal operation of the hair removing unit, such as the rotation of the rotatable cylinders having the detents or the like. Therefore, the hair removing unit can function stably by maintaining the amount of bubbles uniformly.

Preferably, the hair removing unit includes one or more rotatable cylinders having detents, and the bubble retention member includes a bubble collecting plate disposed at a retreated position compared to the rotatable cylinders with respect to a skin surface at a downstream side of a rotation direction of the rotatable cylinders.

In accordance with the above configuration, the hair removing unit includes the rotatable cylinders having the detents, and the bubbles ejected from the rotating rotatable cylinders are collected at the downstream side of the rotation direction of the rotatable cylinders. As a consequence, the bubble collecting plate is disposed at the downstream side thereof.

Accordingly, the bubbles can be effectively collected. Besides, the bubble collecting plate is disposed at the retreated position compared to the rotatable cylinders with respect to the skin surface. As a result, it is possible to collect bubbles newly provided from the skin surface with the movement of the hair removing head.

Preferably, the bubble collecting plate has openings.

In accordance with the above configuration, it is possible to discharge via the openings the bubbles excessively provided from the skin surface with the movement of the hair removing head.

Therefore, the hair removal function can be ensured by maintaining the amount of bubbles uniformly.

Preferably, the hair removing unit includes one or more rotatable cylinders having detents, and the bubble retention member includes a wiper disposed at the position same as the rotatable cylinders or at a protruded position compared to the rotatable cylinders with respect to a skin surface at an upstream side of the rotation direction of the rotatable cylinders.

In accordance with the above configuration, the hair removing unit includes the rotatable cylinders having the detents, and the bubbles remaining at the upstream side of the rotation direction of the rotatable cylinders are wiped by the wiper. The wiper is disposed at the position same as the rotatable cylinders or at a protruded position compared to the rotatable cylinders with respect to the skin surface.

Thus, the bubbles can be used without being wasted. Further, as in the case of removing hairs with a razor, it is possible to reduce time required to clean bubbles, which is convenient to use, and also possible to check the completion of the hair removal operation.

Preferably, the wiper has a roller disposed in parallel with the rotatable cylinders and a link mechanism for biasing the roller toward the skin surface.

In accordance with the above configuration, the close contact between the wiper and the skin surface can be made and, hence, the bubbles can be collected more effectively.

### BRIEF DESCRIPTION OF THE DRAWINGS

The objects and features of the present invention will become apparent from the following description of embodiments, given in conjunction with the accompanying drawings, in which:

FIG. 1 illustrates a perspective view of an exterior structure of a hair removing apparatus in accordance with an embodiment of the present invention;

FIG. 2 illustrates a cross sectional view taken along line II-II of FIG. 1;

FIG. 3 illustrates a cross sectional view taken along line III-III of FIG. 1;

FIG. 4 illustrates a cross sectional view taken along line IV-IV of FIG. 1;

FIG. 5 illustrates a perspective view of a head frame;

FIG. 6 illustrates a detailed exploded perspective view of a wiper in the head frame; and

FIGS. 7A and 7B respectively illustrates a cross sectional view for explaining an operation of the wiper.

### DETAILED DESCRIPTION OF THE EMBODIMENT

Embodiments of the present invention will now be described with reference to the accompanying drawings which form a part hereof.

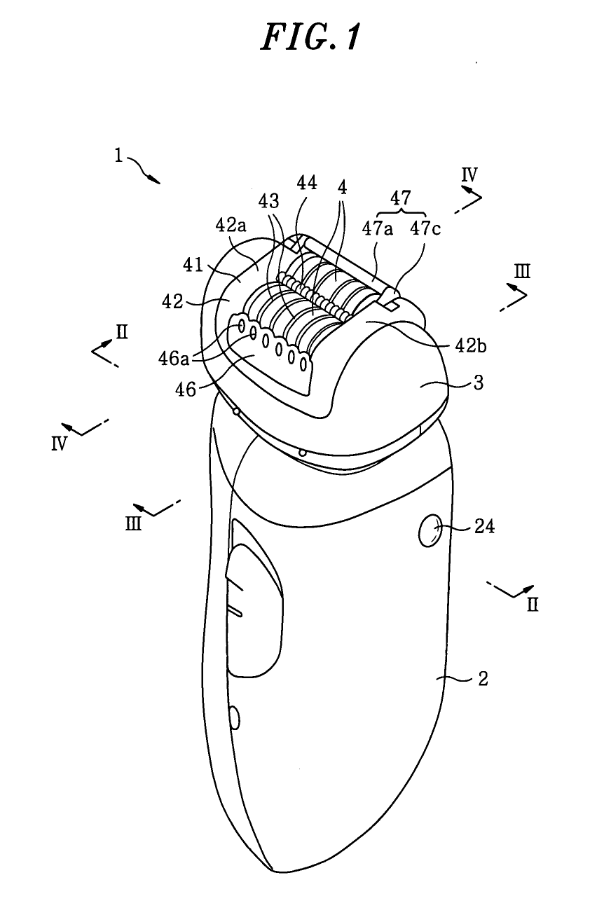

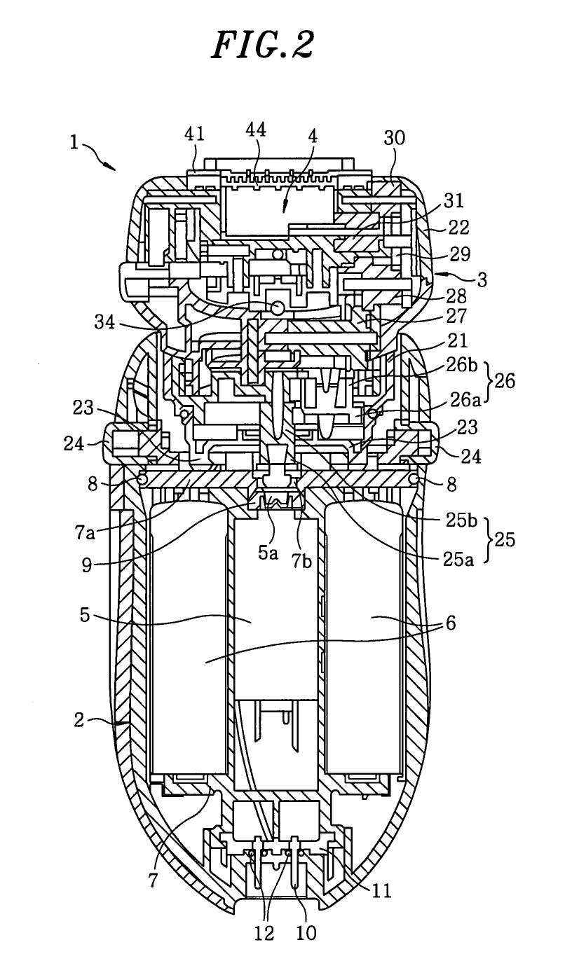

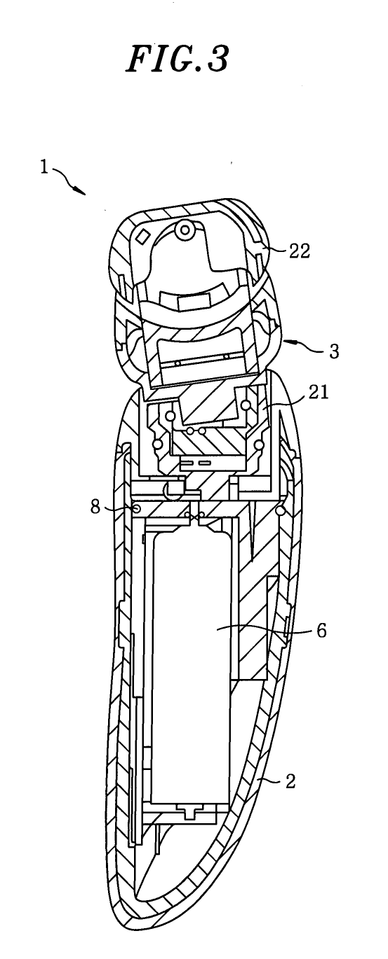

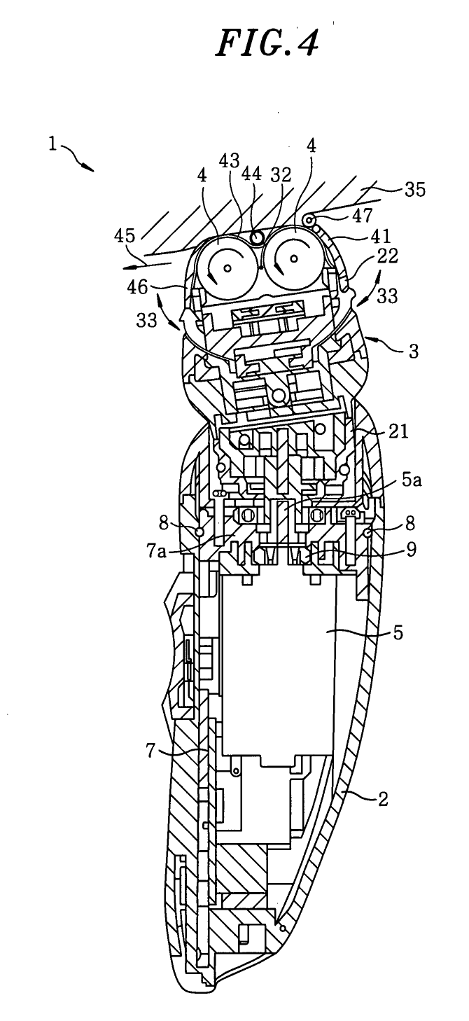

FIG. 1 illustrates a perspective view of an exterior structure of a hair removing apparatus 1 in accordance with an embodiment of the present invention; FIG. 2 illustrates a cross sectional view taken along line II-II of FIG. 1; FIG. 3 illustrates a cross sectional view taken along line III-III of FIG. 1; and FIG. 4 illustrates a cross sectional view taken along line IV-IV of FIG. 1. The hair removing apparatus 1 includes a water-resistant body case 2 having a handheld configuration; and a hair removing head having a hair removing unit, the hair removing head being detachably attached at an upper portion of the water-resistant body case 2.

The hair removing unit includes one or more rotatable cylinders 4, each having a plurality of detents on an outer peripheral surface thereof. When a motor 5 accommodated in the body case 2 and serving as a driving source is driven to rotate the rotatable cylinders 4, the detents catch hairs and pull out the hairs from a skin surface. To be specific, each detent has a fixed detent and a movable detent which together form a pair. Further, levers inserted in the rotatable cylinders 4 to pass therethrough are shifted in axial directions of the rotatable cylinders 4 by the rotation of the rotatable cylinders 4. Accordingly, the movable detent is shifted to be close to or away from the fixed detent, thus catching and pulling out the hairs. The hair removal mechanism and the detailed hair removal operation are described in Japanese Patent Laid-open Application No. 2001-149135.

The body case 2 has an envelope shape with upper portion thereof open and accommodates therein a base 7 where the motor 5 or a rechargeable battery 6 is installed. The base 7 has a top surface plate 7a whose peripheral portion is watertightly sealed by an O-ring 8 with respect to an inner peripheral surface of the body case 2. Moreover, a water-resistant member 9 having an M-shaped cross section is fitted to an output terminal of the motor 5, so that an output shaft 5a projects from the water-resistant member 9 toward the hair removing head 3 through a shaft aperture 7b formed on the top surface plate 7a. Further, a plug base 11 on which plug terminal pins 10 are vertically installed is attached to a lower portion of the base 7, and a peripheral portion of each plug terminal pin 10 is watertightly sealed by an O-ring 12 at the lower portion of the body case 2. Therefore, the body case 2 has the water-resistant structure.

The hair removing head 3 has a base unit 21 whose lower portion is inserted into an opening formed at the upper portion of the body case 2 and a head unit 22 that is floatably supported by the base unit 21. The base unit 21 has a pair of hooks 23 at a lower end thereof, and the hair removing head 3 can be separated from the body case 2 by user's manipulation of a release button 24.

Gears 25 to 31 forming a drive transmission are provided in the base unit 21 and the head unit 22. When the hair removing head 3 is attached to the body case 2, the output shaft 5a of the motor 5 is inserted into a cylindrical coupling portion 25a of the gear 25, thereby forming an input terminal of driving force. A gear unit 25b connected to the coupling portion 25a is engaged with a gear unit 26a of the gear 26, and a gear formed at an axial end surface of a cylindrical portion 26 connected to the gear unit 26a is engaged with the gear 27. Therefore, a rotation from the motor 5 about an axis line extending in a vertical direction of FIG. 2 is converted to a rotation about an axis line extending in a horizontal direction. The rotation of the gear 27 is appropriately decelerated by the gears 28, 29 and 30 and then is transmitted from a pair of the front and rear gears 31 to the rotatable cylinders 4. Accordingly, the rotatable cylinders 4 rotate in a counterclockwise direction shown in FIG. 4.

As illustrated in FIG. 4, a lower end of the head unit 22 is formed as a convex surface which has an arc-shaped cross section centering around an axis line passing through the side surfaces of the head unit 22, whereas an upper end of the base unit 21 is formed as a concave surface which has an arc-shaped cross section centering around the axis line passing through the side surfaces of the head unit 22. Further, a pivoting fulcrum 32 is provided at an intermediate portion between a pair of front and rear rotatable cylinders 4. The head unit 22 is floatably supported by the base unit 21 so that it can pivot about the pivoting fulcrum 32 forward and backward as shown as arrows 33 of FIG. 4. Further, a coil spring 34 for restoring the head unit 22 pivoting forward and backward to the central position is provided at the lower end of the head unit 22.

By the pivoting of the head unit 22, when the head unit 22 is pressed onto a skin surface 35 of a user while rotating the rotatable cylinders 4, the rotatable cylinders 4 follow irregularity of the skin surface 35, and thus, the detents always catch hairs near the skin surface 35, i.e., near the root of the hairs. Accordingly, stress caused by the hair removal can be reduced and, also, even short hairs can be removed.

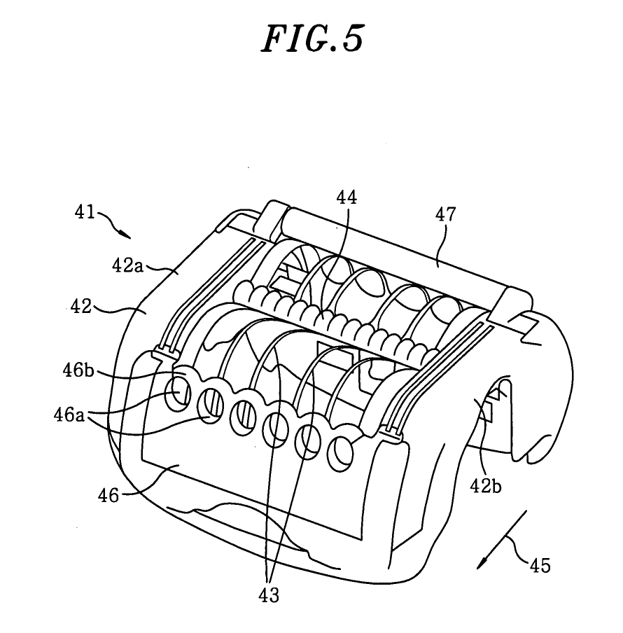

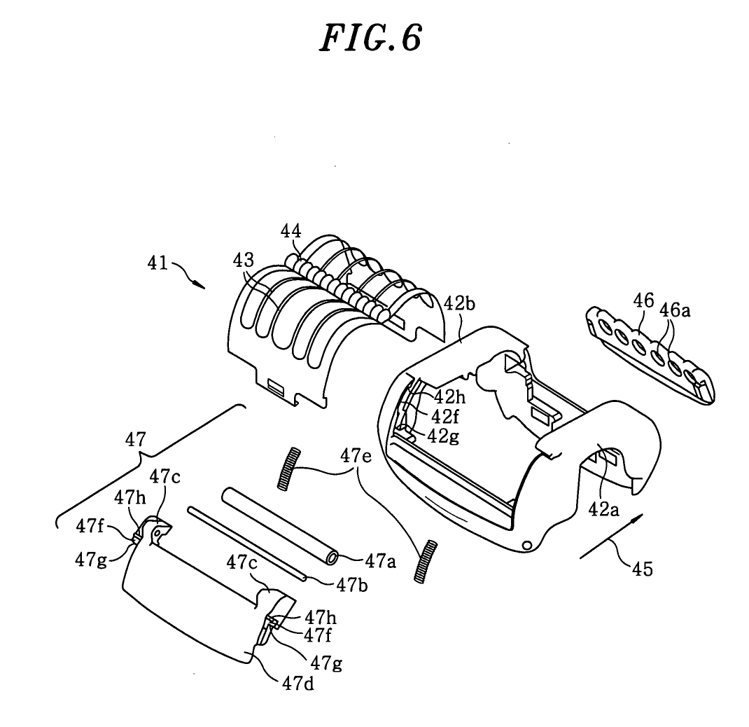

As shown in FIGS. 5 and 6, a head frame 41 is attached to the upper portion of the hair removing head 3. The head frame 41 includes a frame body 42 enclosing the rotatable cylinders 41; and screen wires 43 that are fitted to the frame body 42 and installed in a plurality of lines along the outer peripheral surfaces of the two rotatable cylinders 4, for maintaining a specific gap between the skin surface 35 and the rotatable cylinders 4. The head frame 41 further includes a comb 44 that fills the recess between the two rotatable cylinders 4 to facilitate the sliding of the head frame 41 on the skin surface 35; a bubble collecting plate 46 provided at a leading side of the head frame 41 in terms of a movement direction of the hair removing head 3, the movement direction being indicated by an arrow 45; and a wiper 47 provided at a trailing side of the head frame 41.

In this embodiment, it should be noted that both side portions 42a and 42b of the frame body 42, the bubble collecting plate 46 and the wiper 47 form the bubble retention member that retains therein bubbles and encloses the rotatable cylinders 4 having the detents serving as the hair removing unit.

When the hairs are removed by using soap, the soap bubbles are used to erect hairs and reduce the friction between the skin surface 35 and the hair removing unit formed of the rotatable cylinders 4 having the detents, thereby carrying out the hair removal safely. At this time, the bubble retention member hinders the bubbles from being dispersed by the hair removal operation of the hair removal unit (the rotation of the rotatable cylinders 4). Therefore, the amount of bubbles can be maintained uniformly and the hair removal unit can function stably and properly.

As described above, the hair removing unit includes the rotatable cylinders 4 having the detents, and the bubble collecting plate 46 is disposed at the downstream side of the rotation direction of the rotating rotatable cylinders 4. The reason is that the bubbles ejected from the rotatable cylinders 4 are collected at the downstream side of the rotation direction of the rotating rotatable cylinders 4. That is, bubbles are collected at the leading side of the hair removing head 3 in terms of the movement direction of the hair removing head 3 since the hair removing head 3 is preferably moved in the direction of the arrow 45 so that the skin surface 35 can move in the opposite direction of the rotation direction of the rotatable cylinders 4 to facilitate hair erection. In this embodiment, the bubble collecting plate 46 is disposed at the leading side of the hair removing head 3, so that the bubbles can be effectively collected.

Besides, the bubble collecting plate 46 is disposed at a retreated position compared to the rotatable cylinders 4 with respect to the skin surface 35. That is, a free end surface 46b of the bubble collecting plate 46 is positioned below the uppermost parts of the rotatable cylinders 4 (more specifically, below the uppermost parts of the screen wires 43 to provide a gap between the end surface 46b of the bubble collecting plate 46 and the skin surface 35). As a result, it is possible to collect bubbles newly provided from the skin surface 35 with the movement of the hair removing head 3.

As set forth above, the bubble collecting plate 46 is disposed at the retreated position compared to the rotatable cylinders 4 with respect to the skin surface 35 in order to collect bubbles newly provided from the skin surface 35. However, the end surface 46b thereof is not necessarily flat. Moreover, the bubble collecting plate 46 is not necessarily disposed at the retreated position compared to the rotatable cylinders 4 over the entire length thereof. As shown in FIG. 5, the end surface 46b can be made wavy so that bubbles can be collected through valleys of the wavy end surface 46b.

In this embodiment, one or more openings 46a are formed on the bubble collecting plate 46 and, thus, it is possible to discharge via the openings 46a the bubbles excessively provided from the skin surface 35 with the movement of the hair removing head 3. Accordingly, the hair removal function can be effectively performed by maintaining the amount of bubbles uniformly.

Moreover, in this embodiment, the hair removing unit includes the rotatable cylinders 4 having the detents, and the wiper 47 is disposed at the upstream side of the rotation direction of the rotating rotatable cylinders 4 That is, bubbles are collected at the trailing side of the hair removing head 3 in terms of the movement direction of the hair removing head 3 since the hair removing head 3 is preferably moved in the direction of the arrow 45 so that the skin surface 35 can move in the opposite direction of the rotation direction of the rotatable cylinders 4 to facilitate hair erection.

Besides, the wiper 47 is disposed at the position same as the rotatable cylinders 4 or at a protruded position compared to the rotatable cylinders 4 with respect to the skin surface 35. That is, the uppermost portion of the wiper 47 is positioned flush with or above the uppermost portions of the rotatable cylinders 4 (more specifically, flush with or above the uppermost parts of the screen wires 43). Therefore, the bubbles on the skin surface 35 remaining at the upstream side of the rotation direction of the rotatable cylinders 4 that have completed the hair removal operation can be wiped by the wiper 47 and used without being wasted. Further, as in the case of removing hairs with a razor, it is possible to reduce time required to clean bubbles, which is convenient to use, and also possible to check the completion of the hair removal operation.

As shown in FIG. 6, in this embodiment, the wiper 47 has a roller 47a in parallel with the rotatable cylinders 4; a shaft 47b for rotatably supporting the roller 47a; a wiper base 47d for supporting both end portions of the shaft 47b by using of a pair of right and left supporting pieces 47c; and a pair of right and left springs 47e for elastically biasing the wiper base 47d in a protruded direction with respect to the frame body 42. The wiper base 47d has a pair of right and left guide protrusions 47f. When the guide protrusions 47f are inserted into guide grooves 42f formed on the frame body 42, the wiper base 47d, i.e., the roller 47a, can move back and forth between the frame body 42 and the skin surface 35. Further, when the springs 47e are inserted between receiving surfaces 47g of the guide protrusions 47f and receiving surfaces 42g of the guide grooves 42f, the wiper base 47d, i.e., the roller 47a, is elastically biased from the frame body 42 toward the skin surface 35. At this time, contact surfaces 47h formed at the opposite side of the receiving surfaces 47g of the guide protrusions 47f are made to be in contact with contact surfaces 42h of the frame body 42, so that the wiper base 47d can be prevented from being separated from the frame body 42.

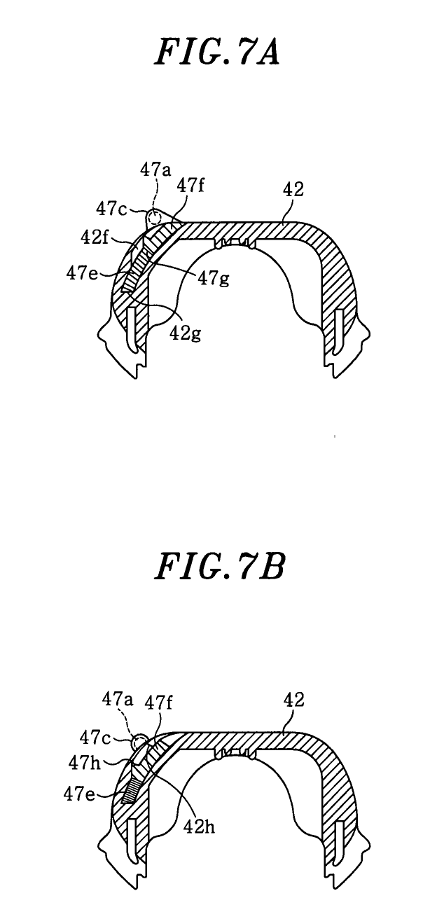

With the above configuration, when the head frame 41 is not in contact with the skin surface 35, the roller 47a is protruded from the frame body 42 toward the skin surface 35 by the elastic force of the springs 47e, as shown in FIG. 7A. On the contrary, when the head from 41 is in a close contact with the skin surface 35, the roller 47a is retreated into the frame body 42 against the elastic force of the springs 47e, as illustrated in FIG. 7B. As a result, close contact between the roller 47a and the skin surface 35 can be made, which makes it possible to collect bubbles more effectively.

While the invention has been shown and described with respect to the embodiments, it will be understood by those skilled in the art that various changes and modification may be made without departing from the scope of the invention as defined in the following claims.

What is claimed is:

1. A hair removing apparatus for removing hairs by using soap comprising:
a water-resistant body case having a driving source therein; and
a hair removing head attached to the water-resistant body case, the hair removing head having a hair removing unit driven by the driving source to pull out the hairs, wherein the hair removing head has a bubble retention member that encloses the hair removing unit to retain soap bubbles therein.

2. The hair removing apparatus of claim 1, wherein the hair removing unit includes one or more rotatable cylinders having detents, and the bubble retention member includes a bubble collecting plate disposed at a retreated position compared to the rotatable cylinders with respect to a skin surface at a downstream side of a rotation direction of the rotatable cylinders.

3. The hair removing apparatus of claim 2, wherein the bubble collecting plate has openings.

4. The hair removing apparatus of claim 1, wherein the hair removing unit includes one or more rotatable cylinders having detents, and the bubble retention member includes a wiper disposed at the position same as the rotatable cylinders or at a protruded position compared to the rotatable cylinders with respect to a skin surface at an upstream side of the rotation direction of the rotatable cylinders.

5. The hair removing apparatus of claim 4, wherein the wiper has a roller disposed in parallel with the rotatable cylinders and a link mechanism for biasing the roller toward the skin surface.
